(19) United States
(12) Patent Application Publication
(10) Pub. No.: US 2026/0073238 A1
(43) Pub. Date: Mar. 12, 2026

(54) TRAINING METHOD AND APPLICATION METHOD FOR SHIP DETECTION NETWORK BASED ON FEDERATED LEARNING

(71) Applicant: WUHAN UNIVERSITY OF TECHNOLOGY, WUHAN (CN)

(72) Inventors: WEN LIU, WUHAN (CN); FENGCHUAN SONG, WUHAN (CN); YANHONG HUANG, WUHAN (CN); ZIHAN WANG, WUHAN (CN)

(21) Appl. No.: 19/315,722

(22) Filed: Sep. 1, 2025

(30) Foreign Application Priority Data
Sep. 6, 2024 (CN) 202411249309.4

(51) Int. Cl. G06N 3/098; G06N 3/048; G06V 10/77; G06V 10/80

(52) U.S. Cl. CPC G06N 3/098; G06N 3/048; G06V 10/7715; G06V 10/806

(57) ABSTRACT

The present invention provides a training method and application method for ship detection network based on federated learning. The training method comprises: constructing a ship detection network and a plurality of local detection networks for a plurality of clients; inputting ship image data into each local detection network, performing dual-branch attention enhancement and feature fusion detection on the ship image data to obtain a ship detection output, determining a prediction total loss based on a dynamic non-monotonic focusing method, and updating local parameters of the local detection network; performing adaptively weighted aggregation on the local parameters to obtain global parameters of the ship detection network, updating the local parameters to obtain a new round of local detection networks, and iteratively updating the local parameters and the global parameters until network performance no longer improves. The present invention enhancing the accuracy of the ship detection network.

### FIELD OF THE DISCLOSURE

The invention relates to the fields of computer vision technology, particularly to a training method and application method for ship detection network based on federated learning.

### BACKGROUND

Visual surveillance for waterway traffic plays a significant role in modern maritime fields. With the rapid development of the shipping industry, the demand for waterway traffic surveillance systems is increasing. An effective waterway traffic surveillance system can not only improve the efficiency of ship traffic management but also prevent accidents, ensure maritime safety, and support key tasks such as maritime law enforcement. With the rapid advancement of deep learning technology, image and video-based waterway traffic surveillance has been significantly improved. The powerful feature extraction capabilities of deep learning algorithms make automatic recognition of ships and other waterway traffic targets possible. However, in large-scale waters, traditional centralized machine learning training processes require access to data from various departments. For the maritime field, centralized machine learning methods struggle to meet the privacy and security requirements of various maritime regulatory departments.

To ensure the privacy and security of data from various maritime regulatory departments (clients) during the training process, federated learning, as a distributed machine learning method, has gradually attracted the attention of researchers. Federated learning allows multiple waterway traffic regulatory departments to train their respective models using their own datasets and share the trained network parameters, collaboratively training a machine learning model while guaranteeing data privacy. However, in current federated learning, due to uneven data distribution from different sources and varying data quality, existing federated learning methods struggle to reasonably utilize these imbalanced and uneven-quality training data during the training process, leading to reduced model accuracy.

Therefore, the existing federated learning methods face the technical problem of being unable to reasonably utilize imbalanced and uneven-quality training data during training, resulting in reduced model accuracy, which requires improvement.

### SUMMARY

In view of this, it is necessary to provide a training method and application method for ship detection network based on federated learning, to solve the technical problem of existing federated learning methods struggling to reasonably utilize imbalanced and uneven-quality training data during training, leading to reduced model accuracy.

To solve the above problems, in one aspect, the present invention provides a training method for ship detection network based on federated learning, comprises:
constructing a ship detection network and a plurality of local detection networks for a plurality of clients;
inputting acquired ship image data into each local detection network, performing dual-branch attention enhancement and feature fusion detection on the ship image data to obtain a ship detection output, determining a prediction total loss based on a dynamic non-monotonic focusing method, and updating local parameters of the local detection network according to the prediction total loss;
performing adaptively weighted aggregation on the local parameters of each local detection network to obtain global parameters of the ship detection network, updating the local parameters according to the global parameters to obtain a new round of local detection networks, and iteratively updating the local parameters and the global parameters until network performance no longer improves, thereby obtaining a trained ship detection network.

In some possible embodiments, the ship image data includes local ship image data acquired by each client, and the local ship image data is input into the corresponding local detection network of the client.

In some possible embodiments, performing dual-branch attention enhancement and feature fusion detection on the ship image data to obtain a ship detection output, comprises: performing feature splitting on the ship image data to obtain a plurality of input feature images;
performing dual-branch attention enhancement on the input feature images to obtain enhanced feature images;
performing multi-scale feature extraction and prediction output on the enhanced feature images to obtain the ship detection output.

In some possible embodiments, performing feature splitting on the ship image data to obtain a plurality of input feature images, comprises:

performing convolution on features of the ship image data to generate convolved feature maps, and performing channel-dimensional feature segmentation on the convolved feature maps to obtain a plurality of input feature images.

In some possible embodiments, performing dual-branch attention enhancement on the input feature images to obtain enhanced feature images, comprises:
performing height average pooling and width average pooling on the input feature images respectively to obtain a height feature map and a width feature map;
passing the height feature map and the width feature map sequentially through 1×1 convolution, sigmoid activation function, weighted merging, and group normalization to obtain a first branch feature;
performing 3×3 convolution on the input feature images to obtain a second branch feature;
passing the first branch feature sequentially through 2D average pooling and softmax activation function, then performing matrix multiplication to fuse the second branch feature to obtain a first attention feature; passing the second branch feature sequentially through 2D average pooling and softmax activation function, then performing matrix multiplication to fuse the first branch feature to obtain a second attention feature;
merging the first attention feature and the second attention feature, then passing through a sigmoid activation function to obtain a cross-spatial attention weight, and performing feature weighting on the input feature images according to the cross-spatial attention weight to obtain the enhanced feature images.

In some possible embodiments, determining a prediction total loss based on a dynamic non-monotonic focusing method, comprises:
performing loss calculation on the ship detection output based on a dual-layer distance attention mechanism to obtain an initial bounding box loss;
determining an exponential moving average based on an iteration round number, determining an anchor box outlier degree based on the exponential moving average, determining a non-monotonic focusing coefficient based on the anchor box outlier degree, and determining a bounding box regression loss based on the non-monotonic focusing coefficient and the initial bounding box loss;
determining a prediction probability loss and a classification loss based on the ship detection output;
determining the prediction total loss based on the bounding box regression loss, the prediction probability loss, and the classification loss.

In some possible embodiments, performing adaptively weighted aggregation on the local parameters of each local detection network to obtain global parameters of the ship detection network, comprises:
determining aggregation weights based on an amount of valid data in the ship image data of each client;
performing adaptive weighted aggregation on the local parameters according to the aggregation weights to obtain the global parameters of the ship detection network.

In another aspect, the present invention also provides an application method for ship detection network, comprising:
acquiring an image of a ship to be detected;
inputting the image of the ship to be detected into a trained ship detection network to obtain a ship detection result; and generating a maritime surveillance protocol based on the ship detection result;
wherein, the trained ship detection network is determined according to the aforementioned training method for ship detection network based on federated learning.

In another aspect, the present invention also provides an electronic device, comprising a processor, a memory, and a computer program stored on the memory and executable on the processor, wherein when the processor executes the program, it implements the aforementioned training method for ship detection network based on federated learning and/or the aforementioned application method for ship detection network.

In another aspect, the present invention also provides a computer-readable storage medium, having a computer program stored thereon, wherein when the computer program is executed by a processor, it implements the aforementioned training method for ship detection network based on federated learning and/or the aforementioned application method for ship detection network.

The beneficial effects of adopting the aforementioned embodiments are as follows: the training method for ship detection network based on federated learning provided by the embodiments of the present invention first constructs a ship detection network and a plurality of local detection networks for a plurality of clients; then inputs the acquired ship image data into each local detection network, performs dual-branch attention enhancement and feature fusion detection on the ship image data to obtain a ship detection output, determines a prediction total loss based on a dynamic non-monotonic focusing method, and updates local parameters of the local detection network according to the prediction total loss; finally, adaptively weighted aggregates the local parameters of each local detection network to obtain global parameters of the ship detection network, updates the local parameters according to the global parameters to obtain a new round of local detection networks, and iteratively updates the local parameters and the global parameters until network performance no longer improves. During the federated learning process, the present invention learns more comprehensive feature information through dual-branch attention enhancement, balances training data of different qualities through dynamic non-monotonic focusing, and balances training data of different distributions through adaptive weighted aggregation of local parameters. This enables the reasonable utilization of training data from various clients while protecting their data privacy, effectively improving the accuracy of the ship detection network trained via federated learning.

### BRIEF DESCRIPTION OF THE FIGURES

To describe the technical solutions in embodiments of the present invention more clearly, the following briefly introduces the accompanying drawings for describing the embodiments. Apparently, the accompanying drawings in the following description show merely some embodiments of the present invention, and those skilled in the art may still derive other accompanying drawings from these accompanying drawings without making creative efforts.

FIG. 1 is a flowchart of the training method for ship detection network based on federated learning provided by the present invention;

FIG. 2 is a flowchart of the ship detection output provided by the present invention;

FIG. 3 is a flowchart of the dual-branch attention enhancement provided by the present invention;

FIG. 4 is a network structure diagram of the dual-branch attention provided by the present invention;

FIG. 5 is a flowchart of the loss calculation provided by the present invention;

FIG. 6 is a flowchart of the adaptive weighted aggregation of network parameters provided by the present invention;

FIG. 7 is a flowchart of the application method for ship detection network provided by the present invention;

FIG. 8 is a structural diagram of an electronic device provided by the present invention.

### DETAILED DESCRIPTION

The technical solutions in the embodiments of the present invention will be clearly and completely described below with reference to the accompanying drawings in the embodiments of the present invention. Obviously, the described embodiments are only a part of the embodiments of the present invention, not all of them. Based on the embodiments of the present invention, all other embodiments obtained by those skilled in the art without creative effort shall fall within the protection scope of the present invention.

In the description of the embodiments of the present invention, unless otherwise specified, the meaning of “a plurality” is two or more. “And/or”, describing the association relationship of associated objects, means that three relationships may exist, for example: A and/or B, which can mean: A exists alone, A and B exist simultaneously, or B exists alone.

The descriptions “first”, “second”, involved in the embodiments of the present invention are for descriptive purposes only and should not be understood as indicating or implying relative importance or implicitly indicating the quantity of the indicated technical features. Therefore, a technical feature defined with “first”, “second” may explicitly or implicitly include at least one such feature.

Reference to “embodiments” herein means that a particular feature, structure, or characteristic described in connection with the embodiment may be included in at least one embodiment of the present invention. The appearances of the phrase in various places in the specification are not necessarily all referring to the same embodiment, nor are separate or alternative embodiments mutually exclusive to other embodiments. It is explicitly and implicitly understood by those skilled in the art that the embodiments described herein may be combined with other embodiments.

The present invention provides a training method, application method, electronic device, and medium for ship detection network based on federated learning, which are described separately below.

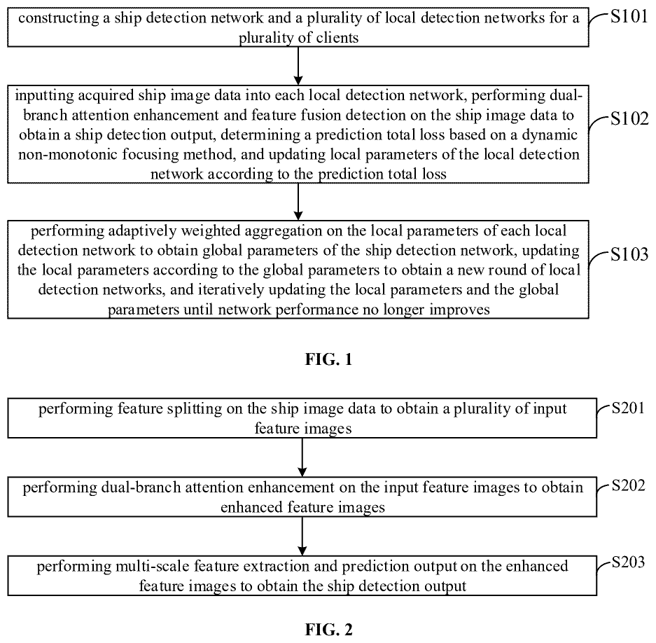

FIG. 1 is a flowchart of the training method for ship detection network based on federated learning provided by the present invention. As shown in FIG. 1, the training method for ship detection network based on federated learning, comprises:
S101, constructing a ship detection network and a plurality of local detection networks for a plurality of clients;
S102, inputting acquired ship image data into each local detection network, performing dual-branch attention enhancement and feature fusion detection on the ship image data to obtain a ship detection output, determining a prediction total loss based on a dynamic non-monotonic focusing method, and updating local parameters of the local detection network according to the prediction total loss;
S103, performing adaptively weighted aggregation on the local parameters of each local detection network to obtain global parameters of the ship detection network, updating the local parameters according to the global parameters to obtain a new round of local detection networks, and iteratively updating the local parameters and the global parameters until network performance no longer improves, thereby obtaining a trained ship detection network.

It should be understood that: the ship detection network obtained through training is used to detect ships in ship image data, so as to provide data reference for subsequent maritime supervision. Moreover, the federated learning-based ship detection network training method provided by the present invention can be implemented in a distributed architecture composed of multiple maritime supervision departments (clients) and a central node or server (such as the server corresponding to a unified maritime supervision center).

Compared with the prior art, the training method for ship detection network based on federated learning provided by the embodiments of the present invention, first constructs a ship detection network and a plurality of local detection networks for a plurality of clients; then inputs the acquired ship image data into each local detection network, performs dual-branch attention enhancement and feature fusion detection on the ship image data to obtain a ship detection output, determines a prediction total loss based on a dynamic non-monotonic focusing method, and updates local parameters of the local detection network according to the prediction total loss; finally, adaptively weighted aggregates the local parameters of each local detection network to obtain global parameters of the ship detection network, updates the local parameters according to the global parameters to obtain a new round of local detection networks, and iteratively updates the local parameters and the global parameters until network performance no longer improves. During the federated learning process, the present invention learns more comprehensive feature information through dual-branch attention enhancement, balances training data of different qualities through dynamic non-monotonic focusing, and balances training data of different distributions through adaptive weighted aggregation of local parameters. This enables the reasonable utilization of training data from various clients while protecting their data privacy, effectively improving the accuracy of the ship detection network trained via federated learning.

In some embodiments, the ship image data includes local ship image data acquired by each client, and the local ship image data is input into the corresponding local detection network of the client.

Specifically, the ship image data used for model training includes local ship image data from various maritime regulatory department clients, acquired by camera devices installed at different clients capturing ships on waterways. To ensure data privacy security among clients during training, each local ship image data is only used for local data feature learning in the corresponding local detection network of its own client.

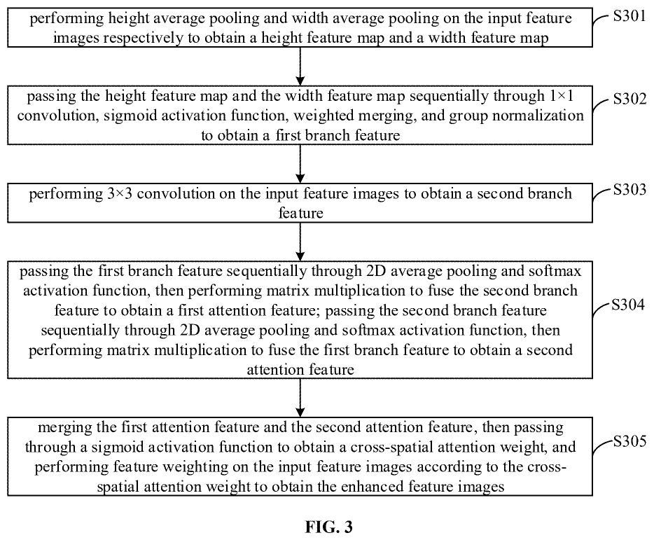

In some embodiments, FIG. 2 is a flowchart of the ship detection output provided by the present invention. As shown in FIG. 2, performing dual-branch attention enhancement and feature fusion detection on the ship image data to obtain a ship detection output, comprises:
S201, performing feature splitting on the ship image data to obtain a plurality of input feature images;
S202, performing dual-branch attention enhancement on the input feature images to obtain enhanced feature images;
S203, performing multi-scale feature extraction and prediction output on the enhanced feature images to obtain the ship detection output.

Specifically, the embodiment constructs a cross-spatial detection network based on the YOLOv8 detection framework. The cross-spatial detection network consists of four components: input, backbone, neck, and head.

The input component is used to process input images to augment data and enhance the model's generalization ability, such as cropping, transformation, and scaling.

The backbone component incorporates feature splitting and dual-branch attention enhancement. Feature splitting reshapes part of the channels into the batch dimension and divides them into multiple sub-features according to the channel dimension, allowing multi-semantic features to be distributed within each group. This effectively prevents detail loss caused by convolutional dimensionality reduction and enables local cross-channel interaction in parallel sub-networks without reducing channels. Dual-branch attention enhancement involves learning features for each group feature through two parallel branches. After channel weights in each branch are updated, the outputs of the two parallel branches are aggregated using cross-spatial interaction to capture enhanced feature images containing pixel-level feature information.

The neck component and head component are based on the YOLOv8 framework structure. The neck component performs multi-scale feature extraction and fusion of features at different scales. Finally, the head component of the network outputs regression results and class probabilities.

In some embodiments, performing feature splitting on the ship image data to obtain a plurality of input feature images comprises:
performing convolution on features of the ship image data to generate convolved feature maps, and performing channel-dimensional feature segmentation on the convolved feature maps to obtain a plurality of input feature images.

Specifically, after the ship image data is input into the local detection network, for each ship image, the embodiment first passes the input ship image through a CBS convolution block for convolution processing to obtain an input feature N∈R^{h×w×c}, where the CBS convolution block consists of a convolutional layer, a normalization layer, and an activation function layer. Then, the input feature is split along the channel dimension into g sub-features

$$N = [ {N}_{0} , {N}_{1} , … , {N}_{g - 1} ] , {N}_{s} ∈ {R}^{h \times w \times \frac{c}{g}}$$

serving as the input feature images for the model.

In some embodiments, FIG. 3 is a flowchart of the dual-branch attention enhancement provided by the present invention. As shown in FIG. 3, performing dual-branch attention enhancement on the input feature images to obtain enhanced feature images, comprises:
S301, performing height average pooling and width average pooling on the input feature images respectively to obtain a height feature map and a width feature map;
S302, passing the height feature map and the width feature map sequentially through 1×1 convolution, sigmoid activation function, weighted merging, and group normalization to obtain a first branch feature;
S303, performing 3×3 convolution on the input feature images to obtain a second branch feature;
S304, passing the first branch feature sequentially through 2D average pooling and softmax activation function, then performing matrix multiplication to fuse the second branch feature to obtain a first attention feature; passing the second branch feature sequentially through 2D average pooling and softmax activation function, then performing matrix multiplication to fuse the first branch feature to obtain a second attention feature;
S305, merging the first attention feature and the second attention feature, then passing through a sigmoid activation function to obtain a cross-spatial attention weight, and performing feature weighting on the input feature images according to the cross-spatial attention weight to obtain the enhanced feature images.

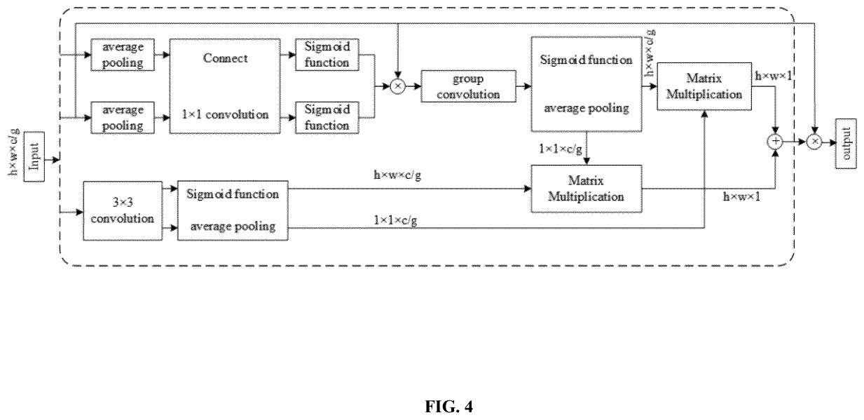

Specifically, to learn more comprehensive feature information, the embodiment adds a dual-branch attention module to the backbone of the local detection network. FIG. 4 is the network structure diagram of the dual-branch attention provided by the present invention. Referring to FIG. 4, the dual-branch attention enhancement involves attention extraction in two branches: 1×1 and 3×3.

For the 1×1 branch, first, the input feature image

$${N}_{s} ∈ {R}^{h \times w \times \frac{c}{g}}$$

is split into two directions, height and width, used for global average pooling to obtain two feature maps. The formulas are expressed as:

$$\begin{matrix}{y}_{s}^{h} ( h ) = \frac{1}{w} {\sum }_{1 \leq j \leq w} {N}_{s} ( h , j ) \\ {y}_{s}^{w} ( w ) = \frac{1}{h} {\sum }_{1 \leq i \leq h} {N}_{s} ( i , w )\end{matrix}$$

Wherein,

$${y}_{s}^{h} ( h )$$

represents the height feature map of Nₛ, yₛ^{w}(w) represents the width feature map of Nₛ.

Then, connect the height feature map and the width feature map to the global receptive field, send the result to a shared 1×1 convolution, activate it with the Sigmoid function to obtain attention weights

$${g}_{s}^{h} and {g}_{s}^{w}$$

respectively. The formulas are expressed as:

$${g}_{s}^{h} = σ ( {F}_{1} ( {y}_{s}^{h} ) )$$

$${g}_{s}^{w} = σ ( {F}_{1} ( {y}_{s}^{w} ) )$$

Wherein, σ denotes the Sigmoid activation function, and F₁(⋅) denotes the 1×1 convolution operation.

Then, perform weighted calculation on the input feature image according to the attention weights to obtain a feature map with attention weights in the height and width directions. The formula is expressed as:

$${y}_{s} ( i , j ) = {N}_{s} ( i , j ) \times {g}_{s}^{h} ( i ) \times {g}_{s}^{w} ( j )$$

Subsequently, the embodiment processes the feature image through group normalization GN(⋅) instead of conventional normalization to obtain the first branch feature y_{gn}(i,j), reducing dependency on batch size. Then perform 2D average pooling to obtain global information nₛ. The formulas are expressed as:

$$\begin{matrix}{y}_{g n} ( i , j ) = GN ( {y}_{s} ( i , j ) ) \\ {n}_{s} = \frac{1}{h \times w} {\sum }_{1 \leq i \leq h} {\sum }_{1 \leq j \leq w} {y}_{g n} ( i , j )\end{matrix}$$

Finally, apply the softmax activation function and Matrix Multiplication (MM) operation to fuse the features from the 3×3 branch, obtaining the first attention feature f_{1×1} of dimension h×w×1. The formula is expressed as:

$${f}_{1 \times 1} = δ ( {n}_{s} ) \times {f}_{0}$$

Wherein, f₀ represents the second branch feature obtained from the 3×3 branch, and δ denotes the softmax activation function.

For the 3×3 branch, the embodiment performs 3×3 convolution on the input feature image

$${N}_{s} ∈ {R}^{h \times w \times \frac{c}{g}}$$

to obtain the second branch feature f₀. The formula is expressed as:

$${f}_{0} = {F}_{2} ( {N}_{s} ( i , j ) )$$

Wherein, F₂(⋅) denotes the 3×3 convolution operation.

Then, perform a 2D average pooling operation on the second branch feature to obtain a pooled result mₛ of dimension

$$1 \times 1 \times \frac{c}{g} .$$

The formula is expressed as:

$${m}_{s} = \frac{1}{h \times w} {\sum }_{1 \leq i \leq h <} {\sum }_{1 \leq j \leq w} {f}_{0} ( i , j )$$

Finally, pass the pooled result through the softmax activation function and perform matrix multiplication with the first branch feature y_{gn}(i,j) from the 1×1 branch, obtaining the second attention feature f_{3×3} of dimension h×w×1. The formula is expressed as:

$${f}_{3 \times 3} = {y}_{gn} ( i , j ) \times δ ( {m}_{s} )$$

After completing attention extraction in both branches, the embodiment merges the outputs of the two branches f_{3×3} and f_{1×1}, passes them through the sigmoid activation function to obtain the cross-spatial attention weight. Finally, weight the input feature image according to the cross-spatial attention weight to obtain the final output enhanced feature image Nₛ. The formula is expressed as:

$${N}_{s} = {N}_{s} ( i , j ) \times σ ( {f}_{1 \times 1} + {f}_{3 \times 3} )$$

In summary, in the dual-branch attention module of the present invention, attention is extracted from the 1×1 and 3×3 branches separately. The 1×1 branch performs global average pooling on features from both height and width directions, concatenates them, passes them through a shared 1×1 convolution followed by sigmoid activation, weighted merging, and group normalization to obtain the first branch feature. The 3×3 branch performs 3×3 convolution on the input feature image to obtain the second branch feature. The features obtained from both branches are averaged pooled and activated, then fused with the other branch via matrix multiplication to obtain the attention features for both branches, thereby determining the cross-spatial attention weight of the input feature image. This enables the detection network to learn more comprehensive feature information, effectively improving the training effectiveness of the ship detection network.

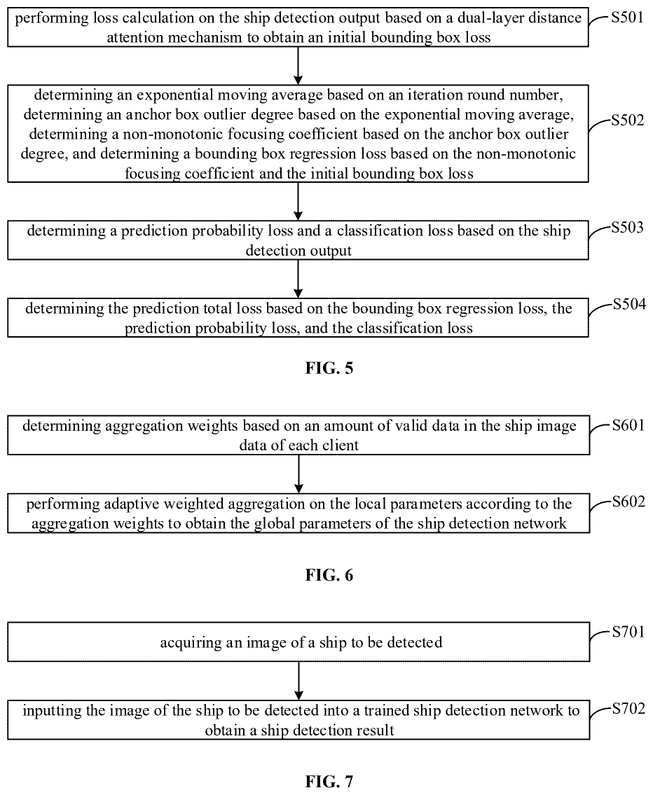

In some embodiments, FIG. 5 is a flowchart of the loss calculation provided by the present invention. As shown in FIG. 5, determining a prediction total loss based on a dynamic non-monotonic focusing method, comprises:
S501, performing loss calculation on the ship detection output based on a dual-layer distance attention mechanism to obtain an initial bounding box loss;
S502, determining an exponential moving average based on an iteration round number, determining an anchor box outlier degree based on the exponential moving average, determining a non-monotonic focusing coefficient based on the anchor box outlier degree, and determining a bounding box regression loss based on the non-monotonic focusing coefficient and the initial bounding box loss;
S503, determining a prediction probability loss and a classification loss based on the ship detection output;
S504, determining the prediction total loss based on the bounding box regression loss, the prediction probability loss, and the classification loss.

Specifically, the prediction total loss L of the local detection network includes the bounding box regression loss L_{WIoU}, the prediction probability loss L_{DFL}, and the classification loss L_{cls}. The prediction total loss L is obtained by the weighted sum of each loss, expressed as:

$$L = {w}_{1} {L}_{WIoU} + {w}_{2} {L}_{DFL} + {w}_{3} {L}_{cls}$$

Wherein, w₁, w₂, and w₃ are the weight values corresponding to the three losses, respectively.

Considering the uneven quality of training data, to balance training data of different qualities and improve the training effectiveness of the local detection network, the embodiment optimizes the bounding box regression loss using a non-monotonic focusing coefficient. For the bounding box regression loss L_{WIoU}, the embodiment first uses a dual-layer distance attention mechanism to obtain the initial bounding box loss, expressed as:

$${L}_{{WIoU}^{′}} = ( exp \frac{{( x - {x}_{gt} )}^{2} + {( y - {y}_{gt} )}^{2}}{{( {W}_{g}^{2} + {H}_{g}^{2} )}^{*}} ) {L}_{IoU}$$

Where x and y represent the horizontal and vertical coordinates of the center point of the predicted bounding box, x_{gt} and y_{gt} represent the horizontal and vertical coordinates of the center point of the ground truth bounding box, W_{g} and H_{g} are the width and height of the smallest enclosing bounding box, and L_{IoU}∈[0, 1] is the Intersection over Union (IoU) loss.

Based on the initial bounding box loss, to improve detection accuracy, the embodiment uses the outlier degree β of the anchor box and constructs a non-monotonic focusing coefficient γ. The formulas are expressed as:

$$β = \frac{{L}_{IoU}^{*}}{\overline{{L}_{IoU}}} ∈ [ 0 , ∞ )$$

$$γ = \frac{β}{δ {α}^{β - δ}}$$

Where L̅_̅{̅I̅o̅U̅}̅ is the exponential moving average with momentum m, and

$${L}_{IoU}^{*}$$

is the gradient gain. The mapping between the outlier degree β and the gradient gain γ is controlled by hyperparameters α and δ. A smaller β value indicates higher anchor box quality. Furthermore, to avoid neglecting low-quality anchor boxes in early training stages, the embodiment designs momentum m to delay the time when the exponential moving average L̅_̅{̅I̅o̅U̅}̅ approaches the true value. During training, when the batch size is n, the momentum m is:

$$m = {}^{tn} \sqrt{0.5} , tn > 7000$$

Where t is the iteration round number of training.

Then the bounding box regression loss L_{WIoU} can be expressed as:

$${L}_{WIoU} = γ {L}_{{WIoU}^{′}}$$

Through this approach, the embodiment ensures that during the middle and late stages of training, L_{WIoU} assigns small gradient gains to low-quality anchor boxes to reduce harmful gradients.

For the prediction probability loss L_{DFL}, it can be expressed as:

$${L}_{DFL} = - {{α}_{t} ( 1 - {p}_{t} )}^{γ} log ( {p}_{t} )$$

Where pₜ is the model's predicted probability for the target class. If the sample is positive, pₜ=p; if the sample is negative, pₜ=1−p, α^{t} is a balancing factor that adjusts the balance between positive and negative samples, γ is a parameter that adjusts the balance between easy and hard samples, and (1−pₜ) is a weighting term for hard-to-distinguish samples, aiming to increase the loss weight of such samples.

For the classification loss L_{cls}, it can be expressed as:

$${L}_{cls} ( p , q ) = \{ \begin{matrix}- q ( q log ( p ) + ( 1 - q ) log ( 1 - p ) ) & q > 0 \\ - α {p}^{γ} log ( 1 - p ) & q = 0\end{matrix}$$

Where p is the predicted IoU-aware classification score, and q is the target score, representing a soft label related to IoU. When q>0, there are no hyperparameters, meaning no decay. When q=0, the negative samples have hyperparameters, γ reduces the contribution of negative samples, and α is a hyperparameter to prevent over-suppression, but overall still reduces the contribution of negative samples.

In some embodiments, FIG. 6 is a flowchart of the adaptive weighted aggregation of network parameters provided by the present invention. As shown in FIG. 6, performing adaptively weighted aggregation on the local parameters of each local detection network to obtain global parameters of the ship detection network, comprises:
S601, determining aggregation weights based on an amount of valid data in the ship image data of each client;
S602, performing adaptive weighted aggregation on the local parameters according to the aggregation weights to obtain the global parameters of the ship detection network.

Specifically, considering the imbalanced in data distribution among different clients and non-independent distributed of data, the embodiment proposes an adaptive weighted aggregation model during the process of aggregating local parameters from each local detection network to obtain global parameters. This adaptive weighted aggregation model sets weights based on the amount of valid data in each client's dataset, ensuring that clients with larger amounts of valid data receive higher attention. For clients with smaller amounts of valid data, which are considered less common in the real world, the present invention reduces their impact on the global model. The formula for adaptive weighted aggregation is expressed as:

$${w}^{( t )} = \frac{1}{K} {\sum }_{k = 1}^{K} \frac{{n}^{( k )}}{n} {w}_{k}$$

Where n represents the total number of all local datasets, n^{(k)} represents the amount of valid data in the dataset of client k, and wₖ represents the parameters distributed by the aggregator to client k in the previous round.

The embodiment continuously performs local training on the local detection networks to obtain local parameters, then adaptively weighted aggregates these local parameters to obtain the global parameters of the ship detection network, and then updates the local parameters of each local detection network using the global parameters. This training process is iterated to achieve model training that reasonably utilizes data from various clients while protecting their data privacy, until the predictive performance of the trained model converges, resulting in a trained ship detection network.

In summary, to reasonably utilize imbalanced and uneven-quality training data during federated learning training and improve model accuracy, the present invention first constructs a ship detection network and a plurality of local detection networks for a plurality of clients; then inputs the acquired ship image data into each local detection network, performs dual-branch attention enhancement and feature fusion detection on the ship image data to obtain a ship detection output, determines a prediction total loss based on a dynamic non-monotonic focusing method, and updates local parameters of the local detection network according to the prediction total loss; finally, adaptively weighted aggregates the local parameters of each local detection network to obtain global parameters of the ship detection network, updates the local parameters according to the global parameters to obtain a new round of local detection networks, and iteratively updates the local parameters and the global parameters until network performance no longer improves. During the federated learning process, the present invention learns more comprehensive feature information through dual-branch attention enhancement, balances training data of different qualities through dynamic non-monotonic focusing, and balances training data of different distributions through adaptive weighted aggregation of local parameters. This enables the reasonable utilization of training data from various clients while protecting their data privacy, effectively improving the accuracy of the ship detection network trained via federated learning.

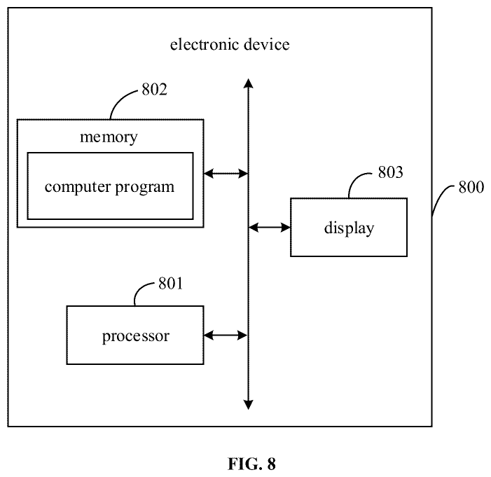

The embodiments of the present invention also provide an application method for ship detection network. Referring to FIG. 7, FIG. 7 is a flowchart of an embodiment of the application method for ship detection network provided by the present invention. As shown in FIG. 7, the application method for ship detection network comprises:
S701, acquiring an image of a ship to be detected;
S702, inputting the image of the ship to be detected into a trained ship detection network to obtain a ship detection result; and generating a maritime surveillance protocol based on the ship detection result;
wherein, the trained ship detection network is determined according to the aforementioned training method for ship detection network based on federated learning. Specifically, the ship detection result is a image with ship types and positional identifiers. For example, the range of the ship, the ship type, and the relative position relationship between ships are identified in the image, which is used to provide a data basis for the subsequent generation of a maritime supervision scheme. Specifically, the maritime supervision scheme may include a maritime target scheduling scheme. For example, the ship detection result includes the ship type and the relative position relationship between ships, and the course and speed of each ship can be adjusted based on all ship types and relative positions to improve the efficiency of maritime ship navigation and reduce the probability of conflict between ships.

In the embodiments of the present invention, first, effectively acquire the image of the ship to be detected. Then, use the aforementioned trained ship detection network to effectively detect the image of the ship to be detected, and output the ship detection result.

As shown in FIG. 8, the present invention also correspondingly provides an electronic device 800. The electronic device 800 includes a processor 801, a memory 802, and a display 803. FIG. 8 only shows part of the components of the electronic device 800, but it should be understood that it is not required to implement all the illustrated components; more or fewer components may be implemented alternatively.

The processor 801 in some embodiments may be a Central Processing Unit (CPU), a microprocessor, or other data processing chip, used to run program code stored in the memory 802 or process data, such as the training method for ship detection network based on federated learning and/or the application method for ship detection network described in the present invention.

In some embodiments, the processor 801 may be a single server or a server group. The server group may be centralized or distributed. In some embodiments, the processor 801 may be local or remote. In some embodiments, the processor 801 may be implemented in a cloud platform. In one embodiment, the cloud platform may include a private cloud, public cloud, hybrid cloud, community cloud, distributed cloud, inter-cloud, multi-cloud, or any combination thereof.

The memory 802 in some embodiments may be an internal storage unit of the electronic device 800, such as a hard disk or memory of the electronic device 800. The memory 802 in other embodiments may also be an external storage device of the electronic device 800, such as a plug-in hard disk equipped on the electronic device 800, a Smart Media Card (SMC), a Secure Digital (SD) card, a Flash Card

Furthermore, the memory 802 may also include both the internal storage unit of the electronic device 800 and external storage devices. The memory 802 is used to store application software installed on the electronic device 800 and various types of data.

The display 803 in some embodiments may be an LED display, liquid crystal display, touch liquid crystal display, OLED (Organic Light-Emitting Diode) touch screen. The display 803 is used to display information of the electronic device 800 and to display a visualized user interface. The components 801-803 of the electronic device 800 communicate with each other via a system bus.

In some embodiments, when the processor 801 executes the ship detection network training program in the memory 802, the following steps are implemented:
constructing a ship detection network and a plurality of local detection networks for a plurality of clients;
inputting acquired ship image data into each local detection network, performing dual-branch attention enhancement and feature fusion detection on the ship image data to obtain a ship detection output, determining a prediction total loss based on a dynamic non-monotonic focusing method, and updating local parameters of the local detection network according to the prediction total loss;
performing adaptively weighted aggregation on the local parameters of each local detection network to obtain global parameters of the ship detection network, updating the local parameters according to the global parameters to obtain a new round of local detection networks, and iteratively updating the local parameters and the global parameters until network performance no longer improves.

In some embodiments, when the processor 801 executes the ship detection network application program in the memory 802, the following steps are implemented:
acquiring an image of a ship to be detected;
inputting the image of the ship to be detected into a trained ship detection network to obtain a ship detection result.

It should be understood that when the processor 801 executes the ship detection network training program and/or the ship detection network application program in the memory 802, besides the functions above, it can also implement other functions. For details, refer to the description in the previous corresponding method embodiments.

Furthermore, the embodiments of the present invention do not specifically limit the type of the mentioned electronic device 800. The electronic device 800 may be a portable electronic device such as a mobile phone, tablet computer, personal digital assistant (PDA), wearable device, laptop computer, etc. Exemplary embodiments of portable electronic devices include, but are not limited to, portable electronic devices equipped with IOS, Android, Microsoft, or other operating systems. The above portable electronic devices may also be other portable electronic devices, such as a laptop computer with a touch-sensitive surface. It should also be understood that in some other embodiments of the present invention, the electronic device 800 may also not be a portable electronic device but a desktop computer with a touch-sensitive surface.

Correspondingly, an embodiment of the present application also provides a computer-readable storage medium. The computer-readable storage medium is used to store a computer-readable program or instructions. When the program or instructions are executed by a processor, they can implement the steps or functions of the training method for ship detection network based on federated learning and/or the application method for ship detection network provided in the aforementioned method embodiments.

It is understood by those skilled in the art that all or part of the process to implement the above embodiments may be accomplished by instructs the relevant hardware (processor, controller) through a computer program that may be stored in a computer readable storage medium. Among them, the computer readable storage medium is disk, optical disc, read-only storage memory or random storage memory.

The above describes in detail the training method and application method for ship detection network based on federated learning provided by the present invention. Specific examples are used herein to explain the principles and implementation of the present invention. The description of the above embodiments is only for helping to understand the method of the present invention and its core ideas. At the same time, for those skilled in the art, according to the ideas of the present invention, there will be changes in specific embodiments and scope of application. Therefore, the content of this specification should not be construed as limiting the present invention.

What is claimed is:

1. A training method for ship detection network based on federated learning, comprises:
constructing a ship detection network and a plurality of local detection networks for a plurality of clients;
inputting acquired ship image data into each local detection network, performing dual-branch attention enhancement and feature fusion detection on the ship image data to obtain a ship detection output, determining a prediction total loss based on a dynamic non-monotonic focusing method, and updating local parameters of the local detection network according to the prediction total loss;
performing adaptively weighted aggregation on the local parameters of each local detection network to obtain global parameters of the ship detection network, updating the local parameters according to the global parameters to obtain a new round of local detection networks, and iteratively updating the local parameters and the global parameters until network performance no longer improves, thereby obtaining a trained ship detection network.

2. The training method for ship detection network based on federated learning of claim 1, the ship image data includes local ship image data acquired by each client, and the local ship image data is input into the corresponding local detection network of the client.

3. The training method for ship detection network based on federated learning of claim 1, performing dual-branch attention enhancement and feature fusion detection on the ship image data to obtain a ship detection output, comprises:
performing feature splitting on the ship image data to obtain a plurality of input feature images;
performing dual-branch attention enhancement on the input feature images to obtain enhanced feature images;
performing multi-scale feature extraction and prediction output on the enhanced feature images to obtain the ship detection output.

4. The training method for ship detection network based on federated learning of claim 3, performing feature splitting on the ship image data to obtain a plurality of input feature images, comprises:
performing convolution on features of the ship image data to generate convolved feature maps, and performing channel-dimensional feature segmentation on the convolved feature maps to obtain a plurality of input feature images.

5. The training method for ship detection network based on federated learning of claim 3, performing dual-branch attention enhancement on the input feature images to obtain enhanced feature images, comprises:
performing height average pooling and width average pooling on the input feature images respectively to obtain a height feature map and a width feature map;
passing the height feature map and the width feature map sequentially through 1×1 convolution, sigmoid activation function, weighted merging, and group normalization to obtain a first branch feature;
performing 3×3 convolution on the input feature images to obtain a second branch feature;
passing the first branch feature sequentially through 2D average pooling and softmax activation function, then performing matrix multiplication to fuse the second branch feature to obtain a first attention feature; passing the second branch feature sequentially through 2D average pooling and softmax activation function, then performing matrix multiplication to fuse the first branch feature to obtain a second attention feature;
merging the first attention feature and the second attention feature, then passing through a sigmoid activation function to obtain a cross-spatial attention weight, and performing feature weighting on the input feature images according to the cross-spatial attention weight to obtain the enhanced feature images.

6. The training method for ship detection network based on federated learning of claim 1, determining a prediction total loss based on a dynamic non-monotonic focusing method, comprises:
performing loss calculation on the ship detection output based on a dual-layer distance attention mechanism to obtain an initial bounding box loss;
determining an exponential moving average based on an iteration round number, determining an anchor box outlier degree based on the exponential moving average, determining a non-monotonic focusing coefficient based on the anchor box outlier degree, and determining a bounding box regression loss based on the non-monotonic focusing coefficient and the initial bounding box loss;
determining a prediction probability loss and a classification loss based on the ship detection output;
determining the prediction total loss based on the bounding box regression loss, the prediction probability loss, and the classification loss.

7. The training method for ship detection network based on federated learning of claim 1, performing adaptively weighted aggregation on the local parameters of each local detection network to obtain global parameters of the ship detection network, comprises:
determining aggregation weights based on an amount of valid data in the ship image data of each client;
performing adaptive weighted aggregation on the local parameters according to the aggregation weights to obtain the global parameters of the ship detection network.

8. An application method for ship detection network, comprises:
acquiring an image of a ship to be detected;
inputting the image of the ship to be detected into a trained ship detection network to obtain a ship detection result; and generating a maritime surveillance protocol based on the ship detection result;
wherein, the trained ship detection network is determined according to the training method for ship detection network based on federated learning according to claim 1.

9. An electronic device, comprising a memory, a processor, and a computer program stored on the memory and executable on the processor, when the processor executes the program, it implements the training method for ship detection network based on federated learning according to claim 1.

10. An electronic device, comprising a memory, a processor, and a computer program stored on the memory and executable on the processor, when the processor executes the program, it implements the application method for ship detection network according to claim 8.

11. A computer-readable storage medium, on which a computer program is stored, when the computer program is executed by a processor, the training method for ship detection network based on federated learning according to claim 1 is implemented.

12. A computer-readable storage medium, on which a computer program is stored, when the computer program is executed by a processor, the application method for ship detection network according to claim 8 is implemented.
